(19) United States
(12) Patent Application Publication
(10) Pub. No.: US 2019/0171053 A1
(43) Pub. Date: Jun. 6, 2019

(54) LIQUID CRYSTAL DISPLAY PANEL AND MANUFACTURING METHOD THEREOF

(71) Applicant: SHENZHEN CHINA STAR OPTOELECTRONICS SEMICONDUCTOR DISPLAY TECHNOLOGY CO., LTD., Shenzhen (CN)

(72) Inventor: Wu CAO, Shenzhen (CN)

(21) Appl. No.: 15/928,319

(22) Filed: Mar. 22, 2018

Related U.S. Application Data
(63) Continuation of application No. PCT/CN2018/071301, filed on Jan. 4, 2018.

(30) Foreign Application Priority Data
Dec. 1, 2017 (CN) 201711250079.3

(51) Int. Cl. G02F 1/1339; G02F 1/1362; G02F 1/1333

(52) U.S. Cl. CPC G02F 1/13394; G02F 1/136209; G02F 1/136286; G02F 1/134309; G02F 2001/13398; G02F 2001/13396; G02F 2201/56; G02F 1/133305

(57) ABSTRACT

The disclosure provides a liquid crystal display panel including a first substrate and a second substrate disposed opposite to the first substrate. The liquid crystal display panel further includes a polymer wall formed between the first substrate and the second substrate, and the liquid crystal display panel is a curved display panel or a flexible display panel. Since a connection area between the polymer wall and the first substrate is relatively large, a connection strength between the polymer wall and the first substrate is strengthened to prevent the polymer wall from being easily detached from the first substrate, thereby avoiding the light leakage and color shift phenomenon. The disclosure also provides a manufacturing method of a liquid crystal display panel.

### RELATED APPLICATIONS

The present application is a continuation of International Application Number PCT/CN2018/071301, filed Jan. 4, 2018, and claims the priority of China Application No. 201711250079.3, filed Dec. 1, 2017.

### FIELD OF THE DISCLOSURE

The disclosure relates to the field of display technology, and in particular to a liquid crystal display panel and a manufacturing method thereof.

### BACKGROUND

Liquid crystal display (LCD) has many advantages such as thin body, energy saving, no radiation and has been widely used. The working principle of a liquid crystal display mainly lies in that liquid crystal molecules are arranged in two parallel substrates, and there are many vertical and horizontal small electric wires in the middle of the two substrates. The liquid crystal molecules can be controlled by changing the electric field intensity of the liquid crystal molecules light intensity to display the image.

The photo spacers are formed between the two substrates. In the curved/flexible display panel, when the two substrates are curved or bent into a curved structure, the photo spacer is easily separated from the substrate to which it is connected, so that light leakage and color shift phenomenon easily occur.

### SUMMARY

To solve the above problems, the disclosure provides a liquid crystal display panel and a manufacturing method thereof.

A liquid crystal display panel includes a first substrate and a second substrate disposed opposite to the first substrate. The liquid crystal display panel further includes a polymer wall formed on the first substrate, and the polymer wall is located between the first substrate and the second substrate. The liquid crystal display panel is a curved display panel or a flexible display panel.

Further, the polymer wall is made of a black photo spacer, and the polymer wall includes a photo spacer region and a black matrix region disposed in connection with the photo spacer region.

Further, the photo spacer region includes a main photo spacer region and an auxiliary photo spacer region, and the main photo spacer region is connected between the second substrate and the first substrate. The auxiliary photo spacer region is disposed on the first substrate, and a gap is formed between the auxiliary photo spacer region and the second substrate.

Further, the first substrate includes a bottom surface disposed on a side of the first substrate away from the second substrate, the bottom surface extends along a first direction and a second direction to form a plane, and the first direction and the second direction is vertical, the polymer wall extends along the first direction, and the liquid crystal display panel may be bent along the second direction.

Further, the liquid crystal display panel further includes a plurality of data line regions arranged at intervals, each of the data line regions extends along a first direction, a number of the polymer wall is plural, and each of the polymer walls is disposed on one of the data line regions.

Further, the liquid crystal display panel further includes a plurality of gate line regions arranged at intervals, each of the gate line regions extends along a second direction, and a number of the polymer wall is plural, each of the polymer walls is disposed on one of the gate line regions.

Further, the first substrate is an array substrate, and the second substrate is a color filter substrate.

Further, the first substrate is a color filter substrate, and the second substrate is an array substrate.

A manufacturing method of a liquid crystal display panel is provided, the liquid crystal display panel is a curved display panel or a flexible display panel, and the manufacturing method includes the following steps:

forming a polymer wall on a first substrate; and

assembling the first substrate and a second substrate into a cell.

Further, the polymer wall is made of a black photo spacer and integrally formed on the first substrate by a selective ultraviolet exposure process, and the polymer wall includes a photo spacer region and a black matrix region disposed in connection with the photo spacer region.

Further, the step of assembling the first substrate and a second substrate into a cell precedes the step of forming a black photo spacer on a first substrate, and an interlayer material of a black photo spacer photosensitive monomer is disposed between the first substrate and the second substrate.

In the liquid crystal display panel and the manufacturing method thereof according to the disclosure, a polymer wall is formed between the first substrate and the second substrate. Since the connection area between the polymer wall and the first substrate is relatively large; the connection strength between the polymer wall and the first substrate is strengthened to prevent the polymer wall from being easily detached from the first substrate, thereby avoiding the light leakage and color shift phenomenon. In addition, the black photo spacer technology is used to form the polymer walls of different heights on the first substrate through a single process, the polymer wall has the dual functions of a photo spacer and a black matrix; thereby reducing the cost and enhancing the light blocking effect and contrast.

### BRIEF DESCRIPTION OF THE DRAWINGS

To describe the technical solutions in the embodiments of the disclosure more clearly, the following briefly introduces the accompanying drawings required for describing the embodiments. Apparently, the accompanying drawings in the following description show merely some embodiments of the disclosure, those of ordinary skill in the art may also derive other drawings from these accompanying drawings without creative efforts.

FIG. 1 is a schematic view of a liquid crystal display panel;

FIG. 2 is a partial cross-sectional view of a liquid crystal display panel according to an embodiment of the disclosure;

FIG. 3 is a schematic view of a portion of a liquid crystal display panel;

FIG. 4 is a partial cross-sectional view of a liquid crystal display panel;

FIG. 5 is a schematic view of another portion of a liquid crystal display panel;

FIG. 6 is a flowchart of a manufacturing method of a liquid crystal panel provided by the disclosure; and

FIG. 7 is a flowchart of another manufacturing method of a liquid crystal display panel provided by the disclosure.

### DETAILED DESCRIPTION OF PREFERRED EMBODIMENTS

The following sections offer a clear, complete description of this disclosure in combination with the embodiments and accompanying drawings. Obviously, the embodiments described herein are only a part of, but not all of the embodiments of this disclosure. In view of the embodiments described herein, any other embodiment obtained by those of ordinary skill in the art skilled in this art without offering creative effort is included in a scope claimed by this disclosure.

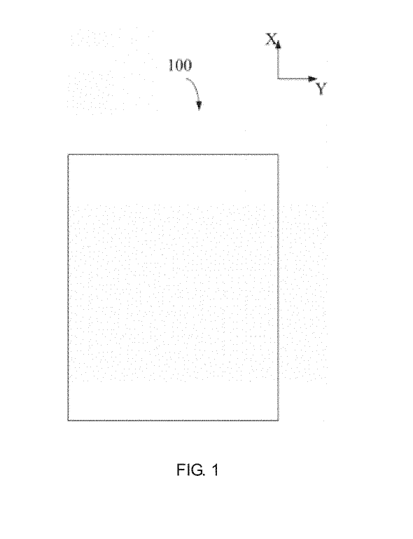

Referring to FIG. 1, the disclosure provides a liquid crystal display panel 100. The liquid crystal display panel 100 extends into a flat plate shape along a first direction X and a second direction Y perpendicular to the first direction X. The liquid crystal display panel 100 is a flexible display panel. The liquid crystal display panel 100 may be bent along the second direction Y. In an embodiment, the liquid crystal display panel 100 is a curved display panel, and the curved display panel is curved along a second direction Y to form a curved surface.

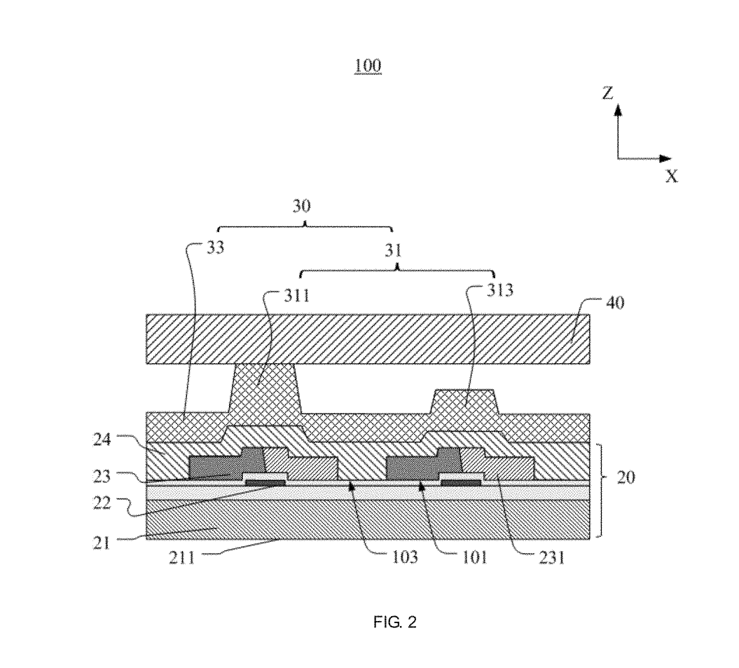

Referring to FIG. 2, the liquid crystal display panel 100 includes a first substrate 20 and a second substrate 40 disposed opposite to the first substrate 20, and a polymer wall 30 formed on the first substrate 20. The polymer wall 30 is interlayered between the second substrate 40 and the first substrate 20. Certainly, a structure such as a liquid crystal layer (not shown) is further disposed between the first substrate 20 and the second substrate 40. To save space, details are not described herein again.

The polymer wall 30 is a black photo spacer (BPS). The polymer wall 30 plays a dual role of a black matrix (BM) and a photo spacer (PS), The BPS is made of a black photosensitive resin or other organic materials. In the present embodiment, the polymer wall 30 is formed on the first substrate 20 by a selective exposure and development using the black photosensitive resin or other organic materials. In other words, the polymer wall 30 including the photo spacer region 31 and the black matrix region 33 is formed on the first substrate 20 through a process.

The polymer wall 30 extends along the first direction X. Further, a length of the polymer wall 30 extending along the first direction X is much larger than a length of the polymer wall 30 extending along the second direction Y. The liquid crystal display panel 100 can be bent along the second direction Y and the polymer wall 30 extends along the first direction X. Since the polymer wall 30 has a larger connection area with the first substrate 20, the polymer wall 30 can be prevented from being detached from the first substrate 20 or sliding on the first substrate 20 during the bending.

Further, in the present embodiment, the first substrate 20 is an array substrate and the second substrate 40 is a color filter substrate.

The first substrate 20 includes a base substrate 21, an electrode layer 22, a color resist layer 23, and a protective layer 24. The base substrate 21 includes a bottom surface 211, a bottom surface 211 is disposed on a side of the substrate 21 away from the second substrate 40. The bottom surface 211 extends into a plane along the first direction X and the second direction Y. The electrode layer 22 is disposed on a side of the base substrate 21 away from the bottom surface 211. The color resist layer 23 is disposed on the electrode layer 22. The color resist layer 23 includes a plurality of color resists 231. The protective layer 24 covers the color resist layer 23 and the electrode layer 22. In the present embodiment, the material of the protective layer 24 is made of organic material. The material of the protective layer 24 may also be made of an inorganic material such as silicon oxide (SiO) or silicon nitride (SiN). In the present embodiment, the substrate 21 is made of a flexible material, which can be a plastic or polymer material such as PI/PET/TAC/PEN/PDMS.

The polymer wall 30 is disposed on the protective layer 24 and extends along a first direction X. The vertical distance of the photo spacer region 31 from the top surface of the first substrate 20 to the bottom surface 211 is a first vertical distance, and the vertical distance of the black matrix region 33 away from the top surface of the first substrate 20 to the bottom surface 211 is a second vertical distance, and the first vertical distance is smaller than the second vertical distance. A gap is formed between the top surface of the black matrix region 33 and the second substrate 40 (not shown). The photo spacer region 31 includes a main photo spacer region 311 and an auxiliary photo spacer region 313.

The main photo spacer region 311 is connected between the second substrate 40 and the protective layer 24 to support the cell thickness, Since both ends of the main photo spacer region 311 are firmly connected between the second substrate 40 and the protective layer 24, no sliding occurs at both ends of the main photo spacer region 311 when the liquid crystal display panel 100 is bent, which can effectively limit the shift caused by the motion of the liquid crystal. Further, since the main photo spacer region 311 is not easily offset, the light leakage and the color shift phenomenon induced by pressing are effectively avoided.

The auxiliary photo spacer region 313 is disposed on the protective layer 24, and a gap (not shown) is formed between the top surface of the auxiliary photo spacer region 313 away from the protective layer 24 and the second substrate 40 to prevent the liquid crystal display panel 100 from being damaged by extrusion. The auxiliary photo spacer region 313 also prevents light leakage.

The polymer wall 30 has a multistage structure, and in the vertical distance from the top surface of the polymer wall 30 away from the first substrate 20 to the bottom surface 211 from high to low in order are the main photo spacer region 311, the auxiliary photo spacer region 313, and the black matrix region 33.

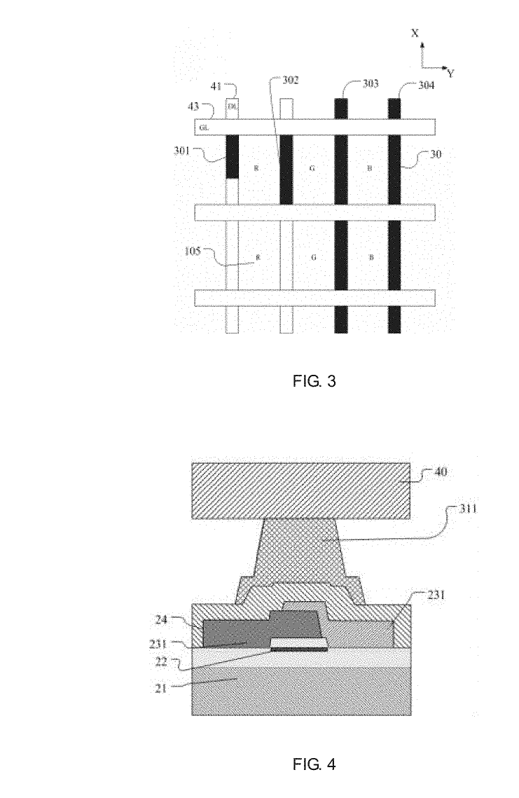

Referring to FIG. 3, the number of the polymer wall 30 is plural, and the length of each of the polymer walls 30 along the first direction X is different. It can be understood that the extending lengths of the plurality of polymer walls 30 along the first direction X can be set to be the same, which is set according to actual needs.

The liquid crystal display 100 further includes a plurality of data line (DL) regions 41 arranged at intervals. Each of the DL regions 41 extends along the first direction X. The number of the polymer wall 30 is plural, and each of the polymer walls 30 are disposed in one of the DL regions 41.

The plurality of polymer walls 30 includes a first polymer wall 301, a second polymer wall 302, a third polymer wall 303, and a fourth polymer wall 304. The first polymer wall 301, the second polymer wall 302, the third polymer wall 303, and the fourth polymer wall 304 are arranged in ascending order along the first direction X. In some embodiments, the number of the first polymer wall 301, the second polymer wall 302, the third polymer wall 303, and the fourth polymer wall 304 are plural, and the plurality of polymer walls 30 is periodically arranged along the second direction in accordance with the first polymer wall 301, a second polymer wall 302, a third polymer wall 303 and fourth polymer wall 304 in the order. It is understood that the plurality of polymer walls 30 may include a plurality of polymer walls of different lengths, and the plurality of polymer walls 30 may be arranged differently.

Further, the liquid crystal display panel 100 further includes a plurality of subpixel regions 105 and a plurality of gate line (GL) regions 43. Each of the DL regions 41 extends along the first direction X. The plurality of DL regions 41 are spaced along the second direction Y. The plurality of GL regions 43 extends along the second direction Y, and the plurality of GL regions 43 are spaced along the first direction X. The DL regions 41 and the GL regions 43 are disposed to cross and surround a subpixel region 105. The liquid crystal display panel 100 is disposed with a color resist 231 in the sub-pixel region 105. The liquid crystal display panel 100 is disposed with data lines (not shown) in the DL region 41. The liquid crystal display panel 100 is disposed with gate lines (not shown) in the GL region 43. The polymer wall 30 is formed in the DL region 41 and has a dual function of a photo spacer and a black matrix. The black matrix layer does not need to be formed by a multiple process, so that the thickness from the top surface of the polymer wall 30 to the bottom surface 211 in the DL region 41 is reduced, conducive to the flow and diffusion of polyimide (PI) solution and liquid crystal molecules.

In an embodiment, the polymer wall 30 extends along the second direction Y, that is, the polymer wall 30 is disposed in the GL region 43. That is, the liquid crystal display panel 100 includes a plurality of GL regions 43 disposed at intervals, and each of the GL region 43 extends along the second direction Y, and the number of the polymer walls 30 is plural, and each of the polymer walls 30 is disposed in one of the GL regions 43.

Further, referring to FIG. 2 again, the first substrate 20 forms a protrusion on a position corresponding to the color resist layer 23, thereby forming a step structure of the first substrate 20. The color resist layer 23 and the protective layer 24 are stacked in the third direction Z. The color resist region 101 and the non-color resist region 103 of the liquid crystal display panel 100 are formed by the color resist layer 23. The color resist region 101 corresponds to a region where the color filter layer 23 is disposed on the first substrate 20 and the non-color resist region 103 corresponds to a region where the color filter layer 23 is not disposed on the first substrate 20. A protrusion will be formed at a position of the color resist region 101 corresponding to the protective layer 24.

The photo spacer region 31 is correspondingly disposed on the color resist region 101, a plane of the step difference layer having the highest step height corresponds to the main photo spacer region 311, and the other positions of the step difference layer corresponds to the black matrix region 33.

A region where two adjacent color resists 231 are connected to each other and a step difference is not formed between the two adjacent color resists 231 is called a first color filter region, the vertical distance of the two color resists 231 away from the top surface 21 to the bottom surface 211 is the same. The main photo spacer region 311 formed in the first color resist region not only has the function of supporting the cell thickness but also prevents the motion of the liquid crystal. In the manufacture of the liquid crystal display panel 100, exposure and development are performed through a photomask having a different light transmittance, thereby forming a multistage polymer wall 30 on the first substrate 20. The polymer wall 30 includes a main photo spacer region 311, an auxiliary spacer region 313, and a black matrix region 33.

Of course, the polymer wall 30 can be fabricated by utilizing the multistage structure of the first substrate 20. For example, referring to FIG. 4, a color resist 231 is partially stacked on the adjacent color resist 231 between two adjacent color resistors 231 to form a step difference layer structure, and this area is referred to as a second color resist region. The main photo spacer region 311 having a certain height is formed on the second color resist region.

It may be understood that the first substrate 20 may be a color filter substrate, and the second substrate 40 may be an array substrate.

It can be understood that the first direction X is not limited to perpendicular to the second direction Y, the third direction Z is not limited to perpendicular to the first direction X, and the third direction Z is not limited to perpendicular to the second direction Y.

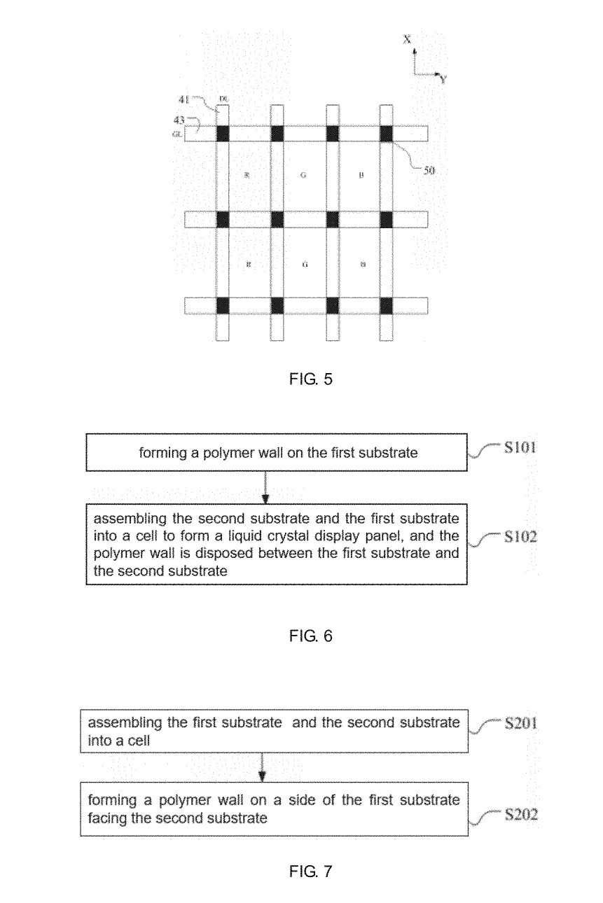

Referring to FIG. 5, the liquid crystal display panel 100 further includes a plurality of spacer structures 50, the spacer structures 50 are formed on the first substrate 20, the spacer structures 50 extends along the third direction Z into a pillar shape; the height of the spacer structures 50 extending along the third direction Z may be set to be different to function as the main photo spacer region, the auxiliary photo spacer region, and the black matrix region, respectively.

Referring to FIG. 6, the disclosure further provides a manufacturing method of a liquid crystal display panel 100, including the following steps:

S101: forming a polymer wall 30 on the first substrate 20.

The polymer wall 30 is made of a black photo spacer and integrally formed on the first substrate 20 by a selective ultraviolet exposure process. The polymer wall 30 includes a photo spacer region 31 and a black matrix region 33 disposed in connection with the photo spacer region 31.

Further, the photo spacer region 31 includes a main photo spacer region 311 and an auxiliary photo spacer region 313.

S102: assembling the second substrate 40 and the first substrate 20 into a cell to form a liquid crystal display panel 100, and the polymer wall 30 is disposed between the first substrate 20 and the second substrate 40.

In the present embodiment, the first substrate 20 is an array substrate, and the second substrate 40 is a color filter substrate.

Referring to FIG. 7, another embodiment of the disclosure further provides a manufacturing method of a liquid crystal display panel 100, including the following steps:

S201: assembling the first substrate 20 and the second substrate 40 into a cell.

Specifically, an interlayer material of a black spacer photosensitive monomer is disposed between the first substrate 20 and the second substrate 40.

S202: forming a polymer wall 30 on a side of the first substrate 20 facing the second substrate 40.

The polymer wall 30 serves as a dual function of a photo spacer and a black matrix. The polymer wall 30 includes a photo spacer region and a black matrix region.

Specifically, the interlayer material containing the black photo spacer is selectively exposed, the film thickness varies in different transmittance regions, and a black photo spacer material is coated on the first substrate to be exposed and developed to form a black spacer having a multistage structure.

In the liquid crystal display panel 100 and the manufacturing method thereof according to the disclosure, the polymer wall 30 is formed between the first substrate 20 and the second substrate 40. Since the connection area between the polymer wall 30 and the first substrate 20 is relatively large, the connection strength between the polymer wall 30 and the first substrate 20 is strengthened so as to prevent the polymer wall 30 from being easily separated from the first substrate 20, thereby avoiding the light leakage and color shift phenomenon. In addition, the black photo spacer technology is used to form the polymer walls 30 of different heights on the first substrate 20 through a single process, the polymer walls 30 have the dual functions of the photo spacer and the black matrix, thereby reducing the cost and enhancing the light blocking effect and contrast.

The above is only the preferred embodiments of the disclosure, and certainly cannot be used to limit the scope of the disclosure. Those skilled in the art may understand that all or part of the processes of the above embodiments may be implemented, and equivalent changes made according to the claims of the disclosure are still within the scope of the disclosure.

What is claimed is:

1. A liquid crystal display panel comprises:
a first substrate; and
a second substrate disposed opposite to the first substrate;
wherein the liquid crystal display panel further comprises a polymer wall formed on the first substrate, the polymer wall is located between the first substrate and the second substrate, and the liquid crystal display panel is a curved display panel or a flexible display panel.

2. The liquid crystal display panel according to claim 1, wherein the polymer wall is made of a black photo spacer, the polymer wall comprises a photo spacer region and a black matrix region disposed in connection with the photo spacer region.

3. The liquid crystal display panel according to claim 2, wherein the photo spacer region comprises a main photo spacer region and an auxiliary photo spacer region, the main photo spacer region is connected between the second substrate and the first substrate; the auxiliary photo spacer region is disposed on the first substrate, and a gap is formed between the auxiliary photo spacer region and the second substrate.

4. The liquid crystal display panel according to claim 1, wherein the first substrate comprises a bottom surface disposed on a side of the first substrate away from the second substrate, the bottom surface extends along a first direction and a second direction to form a plane, and the first direction and the second direction is vertical, the polymer wall extends along the first direction, and the liquid crystal display panel may be bent along the second direction.

5. The liquid crystal display panel according to claim 1, wherein the liquid crystal display panel further comprises a plurality of data line regions arranged at intervals, each of the data line regions extends along a first direction; a number of the polymer wall is plural, and each of the polymer walls is disposed in one of the data line regions.

6. The liquid crystal display panel according to claim 1, wherein the liquid crystal display panel further comprises a plurality of gate line regions arranged at intervals, each of the gate line regions extends along a second direction; a number of the polymer wall is plural, and each of the polymer walls is disposed in one of the gate line regions.

7. The liquid crystal display panel according to claim 1, wherein the first substrate is an array substrate and the second substrate is a color filter substrate.

8. A manufacturing method of a liquid crystal display panel, wherein the liquid crystal display panel is a curved display panel or a flexible display panel, and the manufacturing method comprises the following steps:
forming a polymer wall on a first substrate; and
assembling the first substrate and a second substrate into a cell.

9. The manufacturing method of the liquid crystal display panel according to claim 8, wherein the polymer wall is made of a black photo spacer and integrally formed on the first substrate by a selective ultraviolet exposure process, and the polymer wall comprises a photo spacer region and a black matrix region disposed in connection with the photo spacer region.

10. The manufacturing method of the liquid crystal display panel according to claim 9, wherein the step of assembling the first substrate and a second substrate into a cell precedes the step of forming a black photo spacer on a first substrate, and an interlayer material of a black photo spacer photosensitive monomer is disposed between the first substrate and the second substrate.
